(19) United States
(12) Patent Application Publication
(10) Pub. No.: US 2006/0146765 A1
(43) Pub. Date: Jul. 6, 2006

(54) System for ad hoc sharing of content items between portable devices and interaction methods therefor

(75) Inventors: Bartel Marinus Van De Sluis, Eindhoven (NL); Gerrit Hollemans, Eindhoven (NL); Mathijs Alexander Sommeijer, Delft (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/546,320

(22) PCT Filed: Feb. 16, 2004
(86) PCT No.: PCT/IB04/00408

§ 371 Date: Aug. 19, 2005

Related U.S. Application Data
(60) Provisional application No. 60/448,640, filed on Feb. 19, 2003.
(60) Provisional application No. 60/484,832, filed on Jul. 3, 2003.

(51) Int. Cl. H04Q 7/24

(52) U.S. Cl. 370/338

(57) ABSTRACT

A user interface concept for wireless ad hoc content sharing between portable devices referred to as portable content containers (PCCs). A user-centered design approach is provided enabling users to share content such as music and photos. A variety of physical ways of establishing a secure connections between the PCC devices is provided. In addition, a clear view on the location of the content stored on the devices, and a drag & drop interface is provided. Use is made of separate spaces, each containing the corresponding content and includes a “shared” space such that all connected users may transfer content to and from to their own personal devices. The use of a drag & drop interface in combination with the subdivision of the screen into several spaces, provided the user with a clear view on the content location. The close proximity of users is assumed and enhances social interaction.

The present invention relates to portable device technology including products that implement storage and wireless connectivity, and particularly to a user interface concept for a portable multimedia storage device with the focus on content sharing over ad-hoc networks.

Today's portable “infotainment” (content used for information or entertainment) players have already a large capacity. One example device is the “iPod” digital music player available from Apple Computer, Inc. However, to exchange music or video files they have to be connected to a PC or audio equipment with connections now mostly established with the use of cables (e.g., USB or FireWire) and the user interface of those products is adapted to that situation.

The Portable Content Container (PCC) is considered to be the next generation portable multimedia player enabled by advances in wireless connectivity, digital data storage and compression, display and power supply technologies.

For example, with respect to wireless connectivity, the PCC device may implement the 802.11b standard, also known as Wireless Fidelity (WiFi™) which makes it possible to create a wireless network. In theory, the bandwidth 3 should be sufficient to transfer a TV signal wirelessly with a range of up to 100 m. Within the WiFi™ connection two modes are defined: 1) an infrastructure mode that makes it possible to set up a Wireless Local Area Network (WLAN), for examples, in offices and hotels. This is used to create wireless workspaces. In this mode fixed access points are used to communicate with the portable devices. Each device communicates with one of these fixed access points. Its device's position can be derived from the distance to at least three of these points; 2) the ad hoc mode is used to make a link between portable devices for a peer-to-peer (p2p) connection.

Operating in this mode, it becomes possible to spot other devices that are within range by sending out a signal now and then to check their presence. When another device or access point is discovered, standardization in the field of communication between wireless devices makes that a communication link can be established.

Apart from the described WiFi™ connection, also other wireless applications may be added such as Global Positioning System (GPS) and Internet connections. By adding these, worldwide communication and location determination are possible. This way the

PCC concept becomes more an all-purpose device with the functionality of a portable audio player, a PDA and a mobile phone combined.

Currently, the present quality of wireless connections is not sufficient to be used in a product like a portable multimedia player. Especially using the ad hoc mode linking devices in a secure way is a problem.

With respect to data storage, the PCC device may implement distributed or local storage. With stored, distributed content, every time a specific item is rendered, the information has to be transferred. Storing the content locally is the only solution for portable devices that are used on the move when no stationary database is nearby to ‘stream’ data from. Three types of storage are available: optical (for example the Compact Disc), magnetic (Hard Disc) and solid state (Flash memory). Optical discs are easily exchangeable and relatively cheap; however, a drive is needed. Although, the capacity is increasing and the size decreasing, optical discs in portable devices are sensitive to shocks especially during writing the data. Solid-state memory is one of the fastest, smallest storage available. Because it has no moving parts, it is well protected against shocks. Currently the capacity is insufficient and the price too high. At this moment a hard disc is the cheapest form of storage and its capacity does exceed that of the other two forms of storage. It provides a large capacity on portable size. Currently, a small 1.8-inch hard disc can hold up to 200 Gbyte, while its capacity is still rapidly increasing.

It is understood that music and video requires vast storage capacity and currently, hard discs are the only form of storage that can satisfy this requirement. Since the PCC device combines wireless connectivity with local storage, the memory itself does not have to be exchangeable. Therefore, a hard disc is a preferred solution, however, solid-state memory will be a viable option as the price and capacity will be competitive to that of hard discs.

With respect to the display, the PCC device must implement a color display for rendering photos or videos and to keep the device portable (the size of the present PDA's) a screen size of approximately 4-inch is advantageous. While the screen is illuminated to guarantee good visibility under all conditions, the resolution of present 4-inch screens is 240×320 pixels, minimum. Apart from viewing photos and videos the display can be used for controlling the device. For example, adding a touch screen it becomes possible to operate the device by an onscreen interface, and operable with a stylus.

Almost all portable devices rely on rechargeable batteries. Rendering photos or videos on an illuminated screen consumes lots of energy. Likewise holds for the wireless connection when checking for other devices and when transferring data. With today's capacity the operating time is limited to only a few hours, however, developments like the polymer battery or fuel cell provides a solution for this problem.

Prior art solutions in the field of connecting and transferring data content focussed on the interactive use of portable displays include: “Kidcom” (Kusano, Kidcom project, Personal Intelligent Communicator for girls aged 7-12 years old, Master's Industrial Design Engineering Project, Philips Research, Eindhoven, The Netherlands, Faculty of Industrial Design Engineering, University of Delft, Delft, The Netherlands 1994), which is a communication device for children that can communicate with other devices using a short-range infrared connection. Text notes, pictures can be created and sent to other users. The sending is initiated by pushing a button on top while aiming at another device. An LED and an audible signal provide feedback whether the transmission was successful. To send messages to another device, the infrared ports have to be aligned.

Sony's Pick-and-Drop system described in U.S. Pat. No. 6,470,341 to Rekimoto, is a manipulation technique to copy data from one (computer) screen to another. A more natural way to move things: lifting things up, move and drop is used instead of the well-known drag-and-drop way. To do this, a pen and a touch-screen are used. When the user contacts the screen with a pen and lifts the pen a little, the file is ‘floating’ above the screen using a shadow. When the user completely lifts the pen, the pen virtually holds the file. It is now possible to tap at another screen and copy to the other computer system. Here the mental model of the user is different from the way the system works. For the user it seems like the data is stored locally in the pen, but the pen does not have storage capacity. The pen contains a unique ID tack, which can be read out when close enough to the screen. The network uses this ID to copy the file wirelessly to the designated place, for example another PDA device.

Thus, the new technologies described above make it possible to exchange content wirelessly with other users on the move. This development has great implications for the user interface (UI) of these devices. Aspects like privacy and ‘ad hoc’ networking are becoming very important issues and personal content or content protected by digital rights should not be available for anyone. Until now there is no existing user interface that deals with these aspects.

It would be highly desirable to provide a user interface concept for a portable multimedia storage device such as the PCC with the focus on content sharing using current technology.

It is the usability of the PCC device interactions and the development of a user interface that meets the technological constraints, that is the focus of the invention.

According to the principles of the invention, there is provided a system and method for ad hoc sharing of content stored in portable devices, the system comprising: a means for establishing a communications link to connect a single portable device to one or more other portable devices; a means for generating a visualized shared space on a display area of each portable device of a connected user for facilitating content exchange between connected users via established communications links; and a means for enabling each individual connected user to control transfer of content to and from that user's portable device via said communications link in response to manipulation of items representing user content in said shared space.

The objects, features and advantages of the present invention will become apparent to one skilled in the art, in view of the following detailed description taken in combination with the attached drawings, in which:

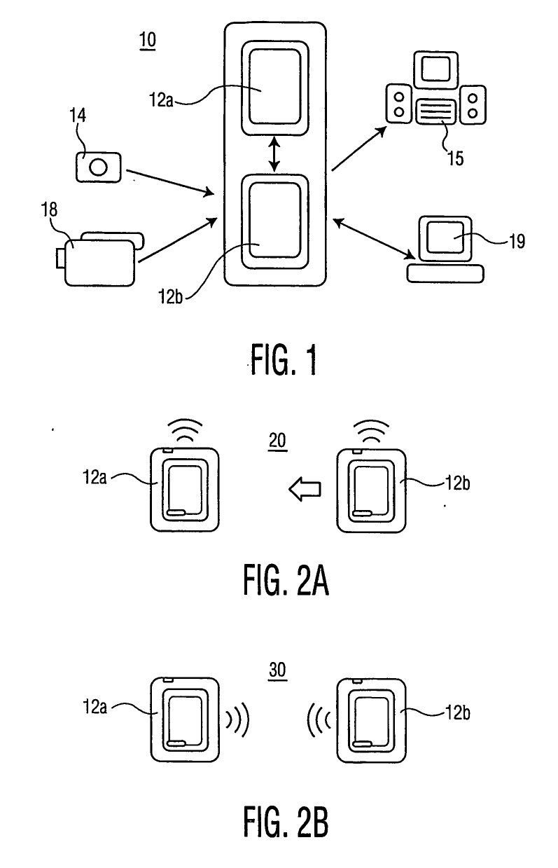

FIG. 1 depicts a generic block diagram depicting the environment 10 of the PCC 12 system that includes input devices, PCC, and playback and back-up devices, according to the invention;

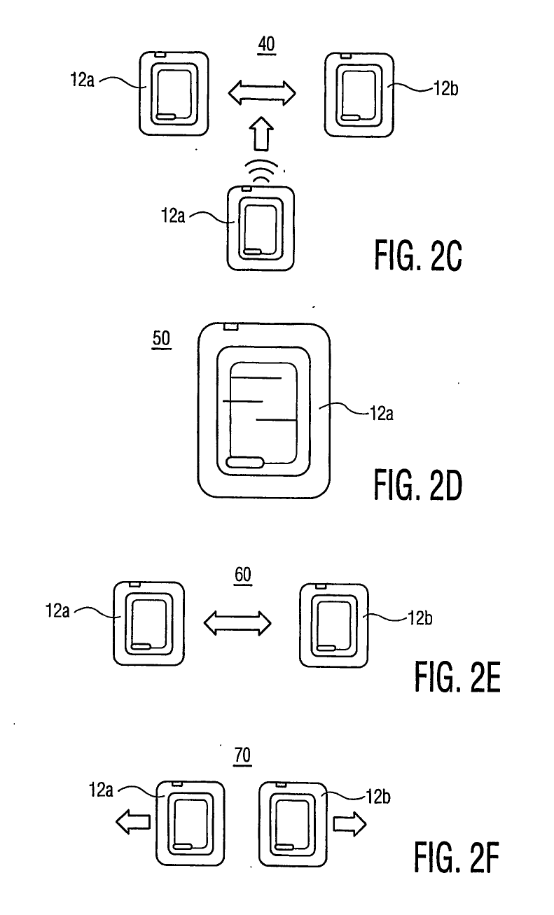

FIGS. 2(a)-2(f) depict example PCC usage scenarios in the “connect-exchange-disconnect” order according to the invention;

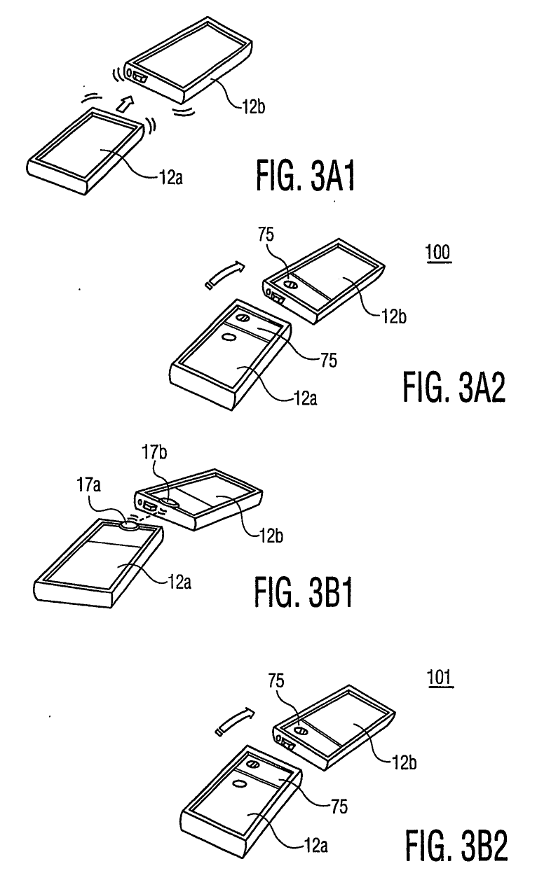

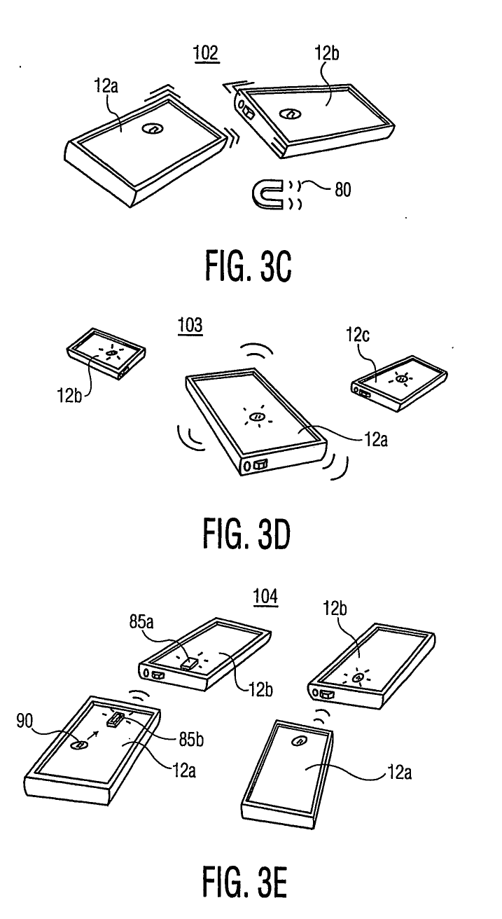

FIGS. 3(a)-3(e) depict examples of the “Being connected” variant for establishing ad hoc transfer of media content between PCC devices;

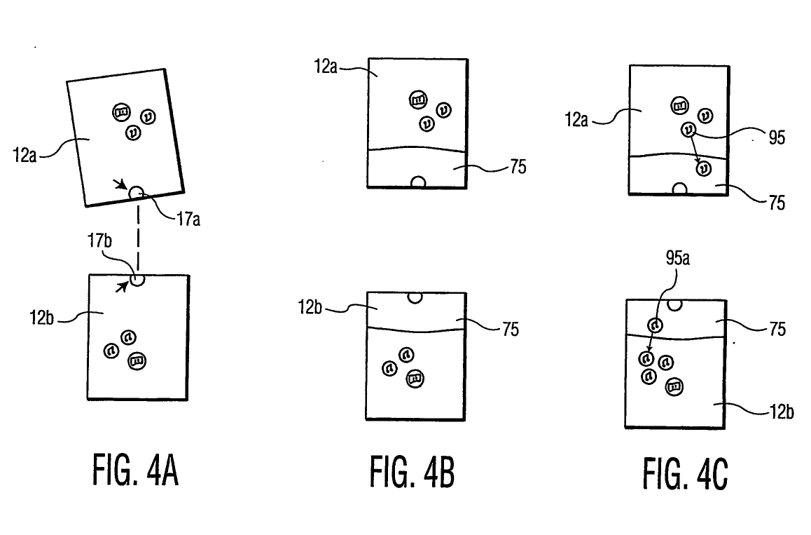

FIGS. 4(a)-4(c) depict in greater detail the ‘point & link’ concept and the visualization of content transfer between PCC devices according to the invention;

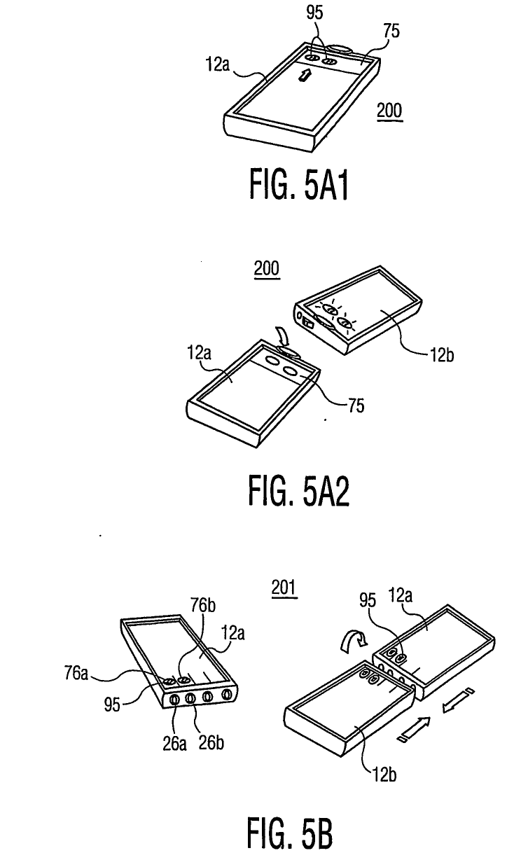

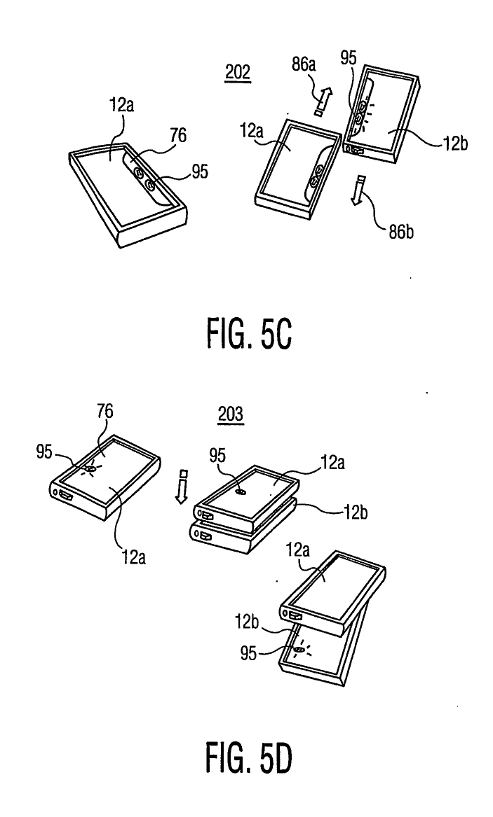

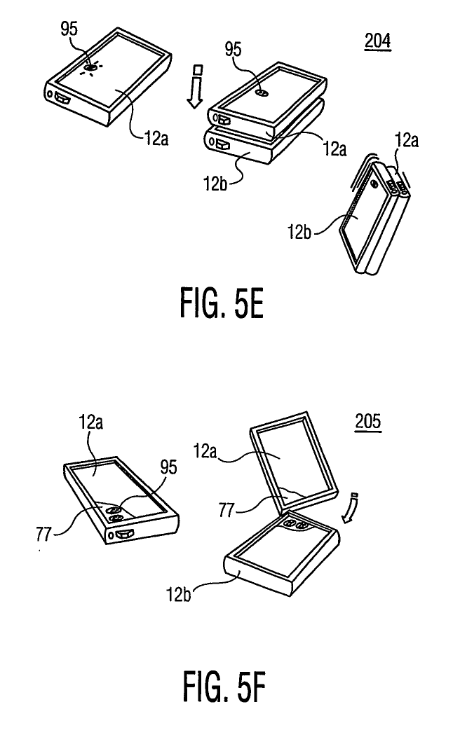

FIGS. 5(a)-5(f) depict examples of the “Connect when sending” variant for establishing ad hoc transfer of media content between PCC devices;

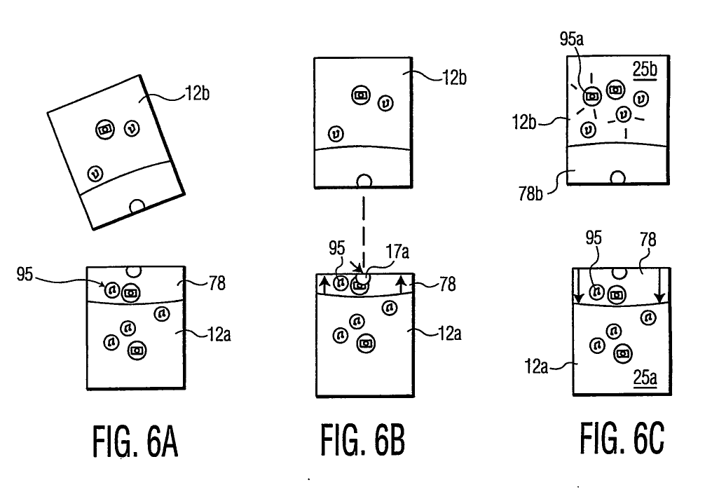

FIGS. 6(a)-6(c) depict in greater detail the ‘point & link’ concept and the visualization of content transfer between PCC devices according to the invention;

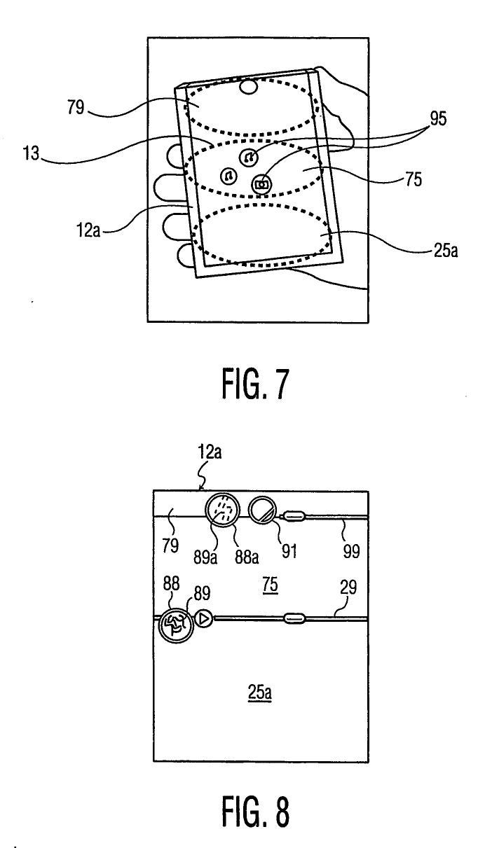

FIG. 7 depicts the generation of the shared space and another space that includes the content of the other device added to the PCC display screen 13 after making contact to the other device;

FIG. 8 illustrates a PCC device having three spaces and a user icon 89a generated for display within a circle 88a and used for indicating connection with that user;

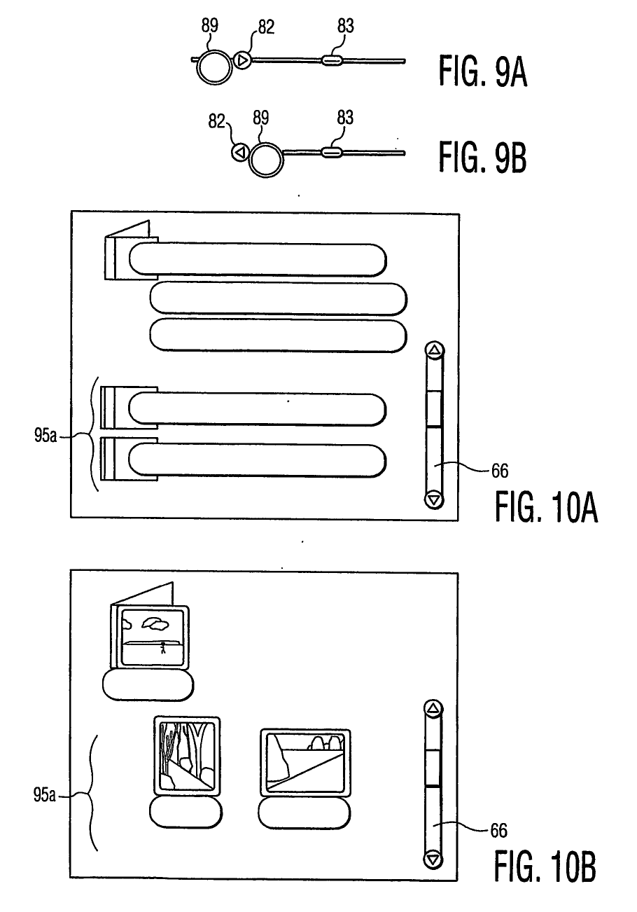

FIGS. 9(a)-9(b) shows two variations of a border bar that borders a space holding the content stored on a PCC device;

FIGS. 10(a) and 10(b) depict selected content in a text view metadata format (music) and a thumbnail view format (photos);

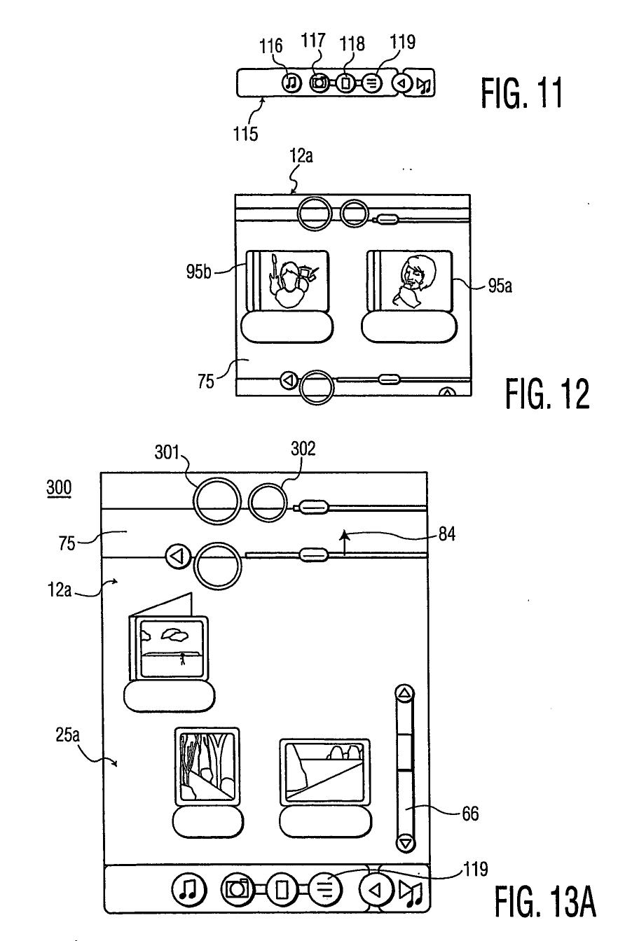

FIG. 11 depicts an exemplary button menu providing buttons enabling functionality for switching between the content type (music and photo) and the presentation mode;

FIG. 12 illustrates two example items 95a,b in an example shared space of a user device 75 shown color coded for user identification;

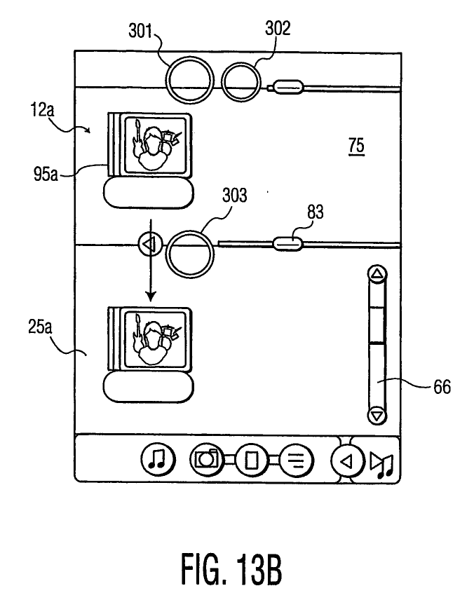

FIGS. 13(a) and 13(b) illustrate an exemplary user interface scenario for navigating through content; and,

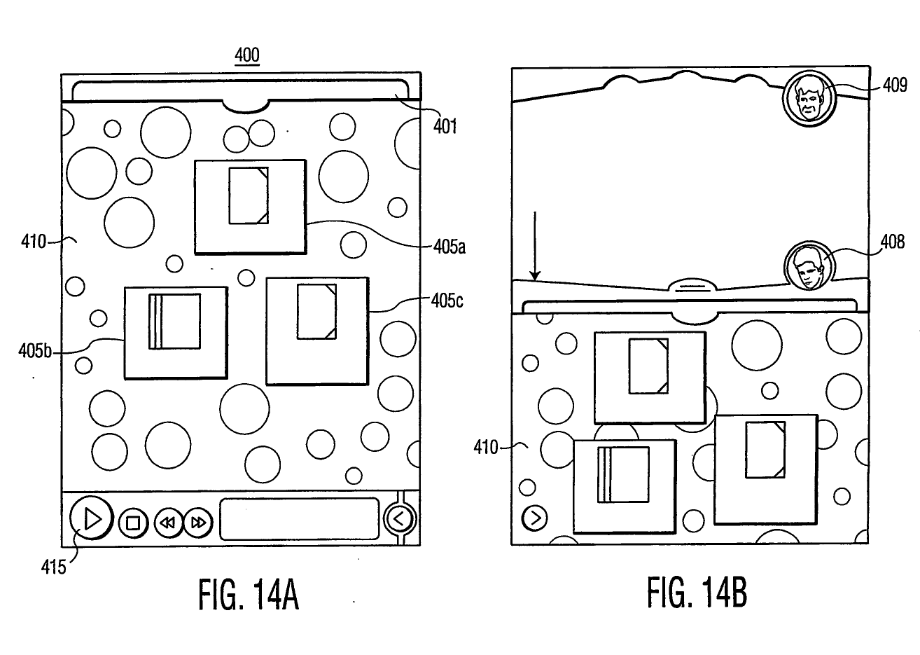

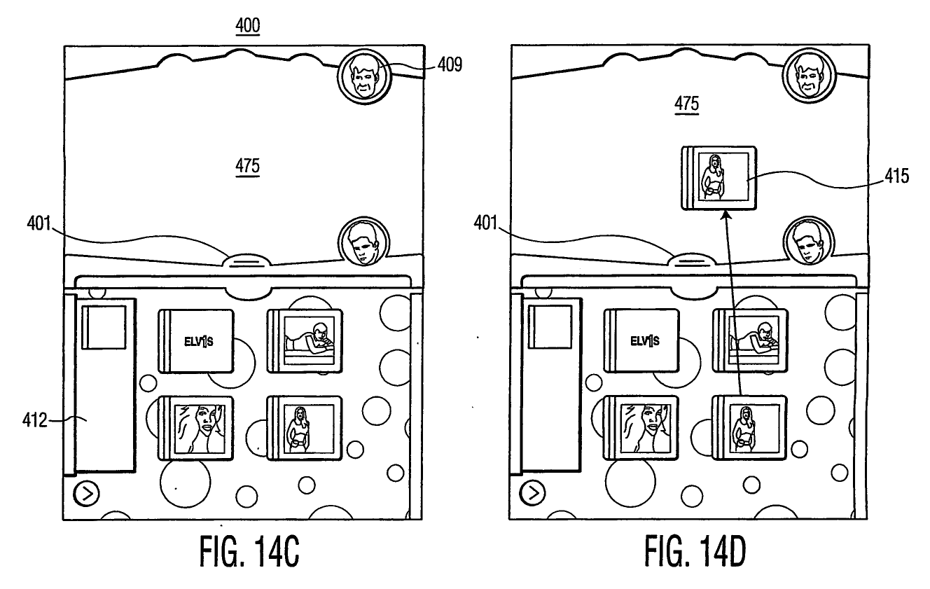

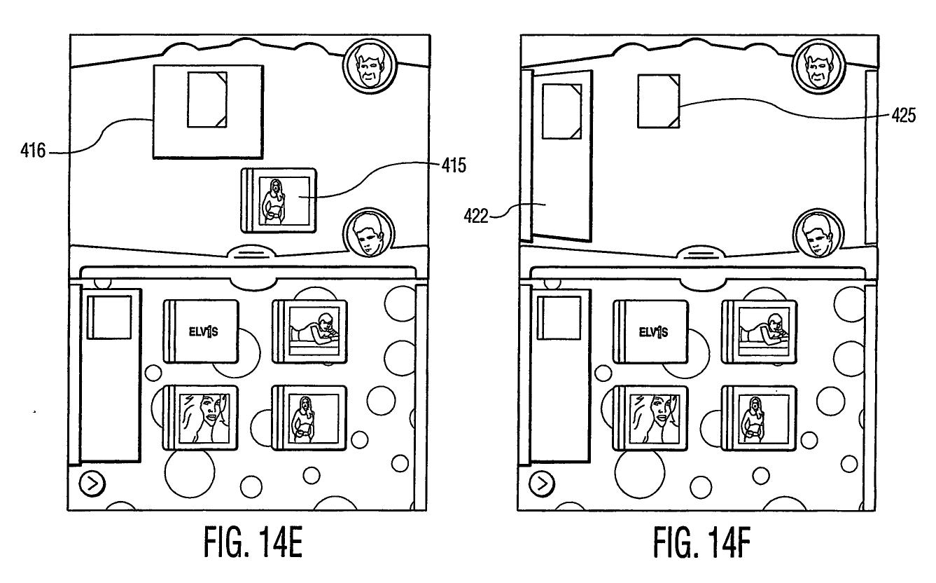

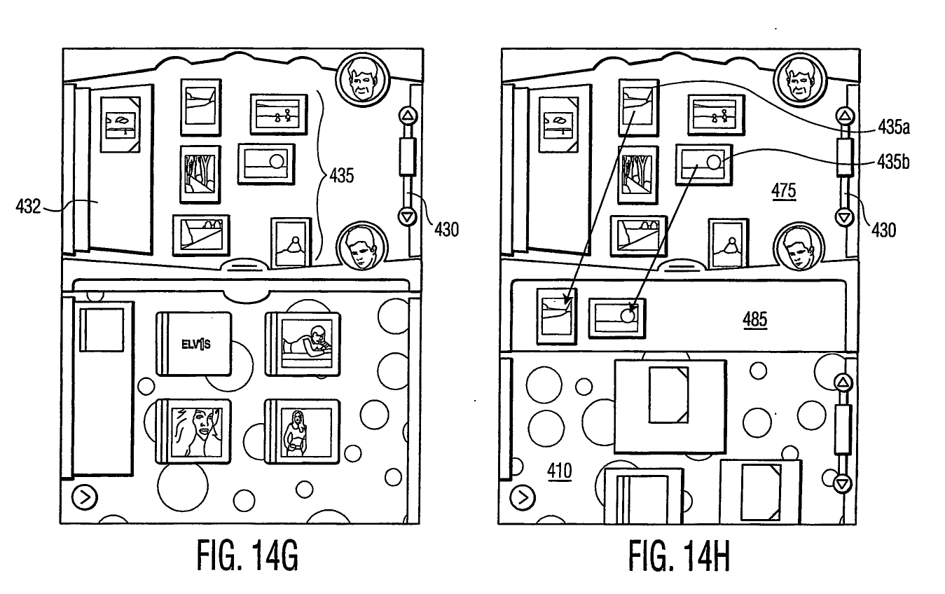

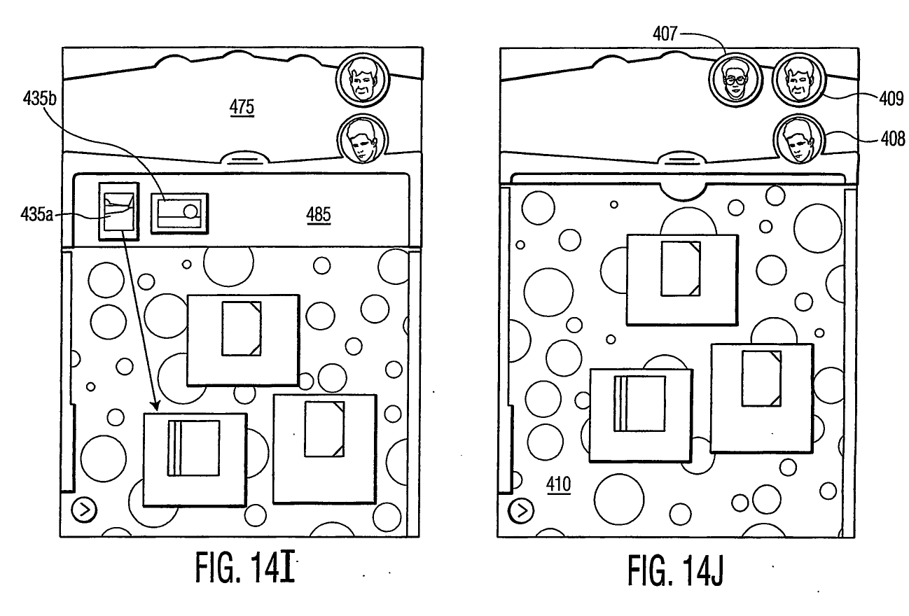

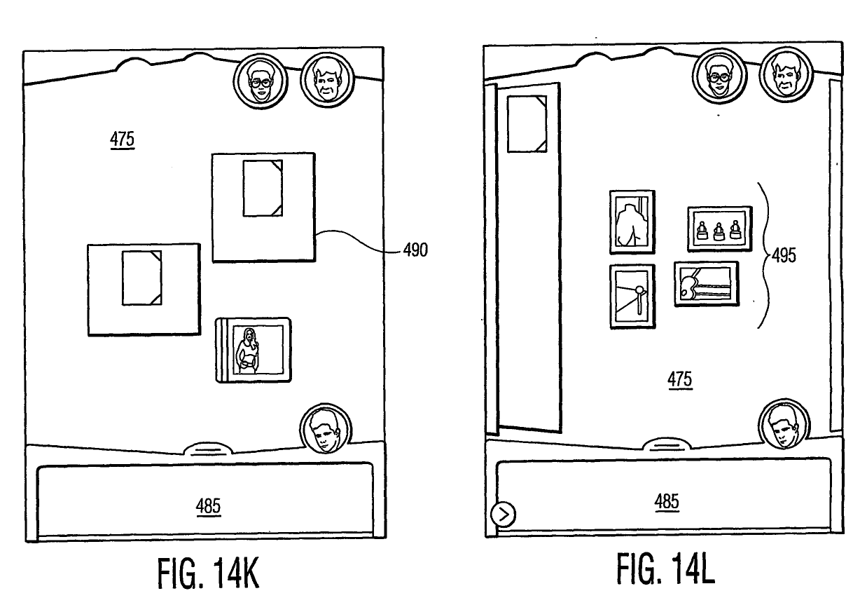

FIGS. 14(a)-14(l) illustrate an exemplary user interface concept according to a further embodiment of the invention.

The Portable Content Container (PCC) is the next step in portable multimedia players having dimensions on the order of the size of current PDAs. Since the concept of an PCC audio/photo player with the added functionality of exchanging items is considered to be one aspect of the PCC, this functionality is illustrated in FIG. 1 as now described. Particularly, FIG. 1 illustrates the environment 10 of the PCC 12 that includes input devices 14, 18 like digital cameras and A/V playback 15 and back-up devices 19, and additionally, the communication between two portable devices (PCCs) 12a, 12b. Particularly, each PCC 12a, 12b is a lightweight and portable device that easily fits in a user's pocket and implements a stylus for the on-screen drag & drop manipulations, as will be further described. Music, photos and videos are obtained from the Internet, capture devices (such as digital cameras 14 or digital camcorders 18) and other PCC's. This content can be rendered on the device itself, however, may be wired or wirelessly connected to stationary devices that provide better quality, such as TV and/or A/V system 15. Since not all content can be exchanged freely, a solution in the field of digital rights is included.

The PCC 12a, 12b is considered the successor of the portable multimedia player, with added functionality to share content wirelessly. For ad hoc communication, a WiFi™ connection with limited range is preferred, but other short range wireless communication standards may be used. Furthermore, it is assumed that users prefer to communicate before they actually exchange music or photos. Thus, the invention assumes a prior face-to-face communication, i.e., social contact, preceding the exchange of content. Thus, a “connect-exchange-disconnect” order is followed so that a user feels in control by being able to decide to whom he/she connects and when he/she aborts the link.

In a first usage scenario 20, depicted in FIG. 2(a), a discussion about the content being exchanged between two users and their respective devices 12a, 12b will precede the actual sharing, so it is assumed people would have close contact. Being in close proximity provides privacy and communication is easy (taking to each other is more effective than other ways of communication). When two users are not in close proximity, the users may not appreciate being detected by others.

FIG. 2(b) depicts a remote user connection scenario 30. As shown in FIG. 2(b), although the person may be in line of sight, the devices 12a, 12b may still not know the presence of each other. The wireless connection may only detect devices within a range of 50 meters, for example. Thus, letting a first device detect other devices automatically when being nearby, all devices within a range are spotted. This results in a list of present devices or friends nearby, from which the user may choose the right one. Since the users are nearby each other, an action executed by the user, which allows him to connect directly and unambiguously to the person standing in front of him, is preferred. Since this action has to be executed every time a connection is made, it has to require low effort. After this connection is made, the distance can be increased to give the users more freedom of movement. Feedback on the connection is given immediately as the feeling of security for the user is important and this feeling is increased when providing clear feedback.

FIG. 2(c) depicts a multi-user scenario 40. Due to privacy reasons a third user (depicted by device 12c) should not be able to connect without the notice of the other two users (devices 12a, 12b). When a third user wants to join the group, it would be consistent to use the same action of connecting. Identifying to both users (or more when multiple users are involved) requires effort. However, when all users are in close proximity they can decide by discussion whether they allow the third user to join or not. Identifying to one user should therefore be enough to join the group.

FIG. 2(d) depicts a content display scenario 50. To provide a clear view to the users about the location of the content, it must be clear which items are owned by the user and which items are not or are being transferred. The interface is easily understood and should not require technical knowledge. The experience of the end user is utilized as much as possible.

FIG. 2(e) depicts a content exchange scenario 60. The process of exchanging items requires less effort for the users, and it is possible to easily share multiple items with multiple users. Digital Rights Management issues have been taken into account. A recipient of content is additionally provided with feedback about the status of the exchange process.

FIG. 2(f) depicts a disconnection scenario 70. Disconnecting is possible at all times by any user. Combining the action of connecting with disconnecting creates a link/unlink association for the user comparable with an on/off button. When devices are connected and the user walks out of range, then automatically the connection is terminated. This also aborts the exchange of items. It is assumed the disconnecting is also regulated by social interaction.

With respect to exchanging content items, a user must indicate to which device he/she wants to communicate. In the absence of wired connections the problem occurs to indicate the desired device to connect with. As the nature of the content may be personal, the user has to be provided with a secure feeling that his content is available for specific users only which requires linking the devices in a secure way without involving other devices by accident. As mentioned, transferring content wirelessly involves a secure transmission as all devices within range can intercept the transferred data. Encryption technologies are thus used to establish this. By encrypting data before transferring it wirelessly, it cannot be decrypted without having the ‘key’. Particularly, a content owner encrypts the content and the information about this process in stored in a key. With this key, the receiver can decrypt the data and transform it back in a readable format. The advantage of using encryption in a multi-user situation is that only the users that posses the key can ‘read’ the data. The owner can provide the key to the users he selects. This key can be combined with personal information about the owner (e.g., a name or icon).

Within encryption, the PGP (Pretty Good Privacy) standard makes use of two keys: a public and a private one. The public one is available for everyone and is used to encrypt information. The private one is held by one person and is used to decrypt the information. Content transferred PGP makes it possible to build a friend list and send content to the selected person, no matter the location.

Furthermore, Infrared communication is a connection standard can be used to wirelessly ‘beam’ data from one device to another. It requires facing the transmitter to the receiver and it only works within a short range. Within infrared connections, there are two modes that may be exploited: A short range, e.g., up to 1.0 meter, connection for sending data called IrDA data. This mode requires the aiming of the infrared port at another infrared port. In this mode, the angle of the beam and the intensity are adjustable. The second mode, called IrDA control functions up to 6 meters, for example, and is used in a wireless mouse and keyboard. It is bidirectional and allows up to eight (8) devices simultaneously.

Furthermore, sensors may determine the location or orientation of the device. Thus, is determining locations in an ad hoc network can be realized with the use of ultrasound transceivers, for example. This technology makes use of sound pulses to determine the relative location of nearby devices. A set of orientation sensors can determine the orientation of a device. Thus, for example, it is possible to determine whether a device is in an upside down position or not.

More particularly, as will be described in greater detail, physical contact may also be used in the key exchange. For example, each PCC is equipped with an infrared port Aligning the infrared ports and pressing a button initiates identification and key exchange between the devices. Once the devices are identified the WiFi™ connection is used to transfer at high speed and wider range. Thus, each device may include a tag that can be read out by other devices when being in very close proximity (centimeters). The tag contains the decryption key and information about the user. To prevent unwanted links, the devices may be held against each other. The action is only performed with the full awareness of both users, like a handshake. The information on the tags can be reprogrammed when the user changes his profile. Furthermore, an infrared beam may be used for the linking. Each device is equipped with an infrared port. Aligning the infrared ports and pressing a button exchange the key and identification between the devices. Once the devices are identified the WiFi™ connection is used to transfer at high speed and wider range. A stylus exchange may also be performed whereby, after two users meet they exchange their stylus which includes a tag; The tag is read out when bringing it close to the user's respective touch screen. Information about the ID of the users and the key are stored in here. Giving the stylus to another person calls for trust. Additional hardware in the stylus is needed. The touch screen, in this instance, cannot be operated by finger.

With respect to the graphical user interface, content to be exchanged has to be represented in a way that makes clear to the user on what location the content is stored and what actions can be performed. As will be explained in greater detail, a graphical user interface that follows the desktop metaphor is established. Preferably, all content items are represented by icons and can be moved and handled like real physical objects. Present users are additionally represented by icons. Here the accessibility and the relation between the items and the users are visualized. In a so-called spaces concept the different locations on the screen are mapped with physical spaces whereby users and content items are moving around in the virtual space. The spaces concept symbolizes the different storage locations. Each storage location (contacted device) is represented by an onscreen space. Thus, when functioning as a stand-alone player only a single space (user's own space) is visible, for example. As will be explained in greater detail, moving items from space to space by drag & drop initiates copying and transferring between the devices.

The conceptual structures for physically linking described herein combined with the spaces interface result in structural concepts that provide solutions for ad hoc linking and exchanging content items.

It should be understood that the connect-exchange portion of the linking includes two actions: connecting to the right user and exchanging the items. In this, two variants appear: 1) a “Being connected” variant whereby a first the device sets up a connection with the other device and, when this connection is established, the exchange of content can be started. During the status of ‘being connected’ content can be transferred until a user disconnects; and 2) a “Connect when sending” variant whereby there is no status of being connected. Every time the user wants to exchange content, he/she makes a new connection, i.e., between the data packages there is no connection.

FIGS. 3(a)-3(e) depict examples of the “Being connected” variant. In a first embodiment 100 depicted in FIG. 3(a) when the devices are brought in close proximity (e.g., less than 10 cm) the link establishes automatically ((FIG. 3(a)(1)). In this embodiment, an infrared transmitter may transmit every few seconds to establish the link automatically with a user in close proximity. Alternately, in a further embodiment 101 depicted in FIG. 3(b)(1), both devices 12a, 12b may be aimed at each other and the user pushes a ‘link’ button 17a, 17b when they are “nearby” (e.g., within 30 cm). In this embodiment, an infrared transmitter is activated by a user to establish the link. Preferably, each device gives feedback about the connection made and once the link is established, the devices do not need to be in those ranges anymore, i.e., the users may keep more distance As depicted by arrows in FIGS. 3(a)(2) and 3(b)(2) and as will be described in greater detail, a virtual shared space 75 is used to share content items by dragging them into the space, which makes them visible to the other connected users. This space is updated for all connected users each time a new item appears. Pressing a button, for example, on the screen, performs the disconnecting.

The variants depicted in FIGS. 3(a)-3(b) represent a ‘point & link’ concept combining an infrared connection with the high speed WiFi™ connection to initiate the contact. Other variants of the “Being connected” concept include: a “Feel the force” type concept 102 as depicted in FIG. 3(c) whereby the devices 12a, 12b implement controllable magnetic forces 80 and an automatic infrared connection such that when users bring their devices closer to each other, they feel (magnetic) resistance getting stronger. When users proceed, suddenly the resistance disappears and a link establishes giving physical feedback. While transfer content items, using the virtual shared space, the range may increase without ending the link. Disconnecting is performed by pressing a soft or hard, button on the device. In a ‘Right out of the sky’ type concept 103 as depicted in FIG. 3(d), one user device 12a is transmitting content items and, all devices, e.g., devices 12b, 12c within range (e.g., less than 1 meter) can pick up this content. No link has to be established and disconnecting is not necessary; the user just walks away. It is understood that this technology however, requires the use of encrypted technology and a ‘buddy list’. In a ‘Radar’ type concept variant 104 as depicted in FIG. 3(e), the use of ultrasound sensors that measure the position of the other devices 12a, 12b may be used such that when one device, e.g., 12a is close to another device, e.g., 12b, representations of the other devices, e.g., in the form of icons 85a,b, appear on the user's screen. When the device moves, the icon on the screen also moves. Content items, also represented as icons 90, are dragged to these icons 85b to transfer content to the specific user. When out of range (e.g., greater than 3 m) the link is automatically broken as depicted in FIG. 3(e).

With further respect to ‘point & link’ concept depicted in greater detail in FIGS. 4(a)-4(c), when two users meet, they point their devices 12a, 12b each with an infrared port located thereon, at each other, and both press the ‘connect’ button 17a, 17b at the same time ((FIG. 5(a)). This action has to be performed in close proximity in order to prevent unwanted connecting by pointing at another device by accident. After exchanging the key and user information the WiFi™ connection takes over and the users do not have to point their device anymore at each other as a status of ‘being connected’ is reached. As depicted in FIG. 5(b), while being connected, people can exchange items. In this situation, a ‘shared space’ 75 is created which is a (virtual) space that holds the information both people exchange. This space only has this function during the contact and disappears after the connection is aborted. Translating this to the onscreen interface it means that after making contact the space 75 appears, where people can freely and securely exchange content items represented as icons 90. Items (icons) that are placed in this space are accessible to all connected users. Particularly, in this embodiment, as depicted in FIG. 5(c), dragging an item 95 from the transferor's device 12a personal space 25a to the shared space 75, makes it visible on the other transferee's device 12b shared space. The item can now by dragged by the other user to his personal space, e.g., space 25b. The downloaded item 95 is displayed in the shared space as contrasted item 95a in order to distinguish already downloaded items. That is, when an item is placed in the shared space, a copy is made from the original. Since the shared space is continuously updated on all connected devices, a copy in the shared space differs from the original on the device of the device owner to indicate who placed it there. This prevents the owner from downloading items to himself. Thus, it is understood that the content stored on the device is displayed outside the shared space in a so-called personal space. Dragging an item from the shared space 75, into the transferee's device ‘personal’ space 25b (that includes the items stored on the own device) starts the transfer from the other device. When all connected users, except for the owner have downloaded an item it disappears from the shared space 75. Each of the connected users can disconnect at any time by pushing the button 17a, 17b again. In the case of two connected users the connection is terminated when one of them disconnects. When more than two users are connected one can leave while the others still are connected. The items placed in the shared space by the disconnecting user will disappear.

FIGS. 5(a)-5(f) depict examples of the “Connect when sending” variant In a first embodiment 200, depicted in FIGS. 5(a)(1)-5(a)(2) a user transferor device 12a first pre-selects the content items (icons) 95 by dragging them in a separate area 75 (FIG. 5(a)(1)), and, then pushes a send button 17a while pointing to start the content transfer to the other (transferee) device 12b (FIG. 5(a)(2)). In this scenario, an infrared connection is combined with the WiFi™ connection.

The variants depicted in FIGS. 5(a)(1) and 5(a)(2) represent a ‘select & shoot’ concept whereby content is first selected and beamed to another user while pointing at the desired device. Both in the selection of the items and in the transfer, the initiative is with the owner. Other variants of the “Connect when Sending” concept include: a “Kiss” type concept 201 as depicted in FIG. 5(b) whereby hard buttons 26a,b are implemented such that content items or media collections represented as icons 95 are placed in a respective space 76a,b relating to a button 26a,b. When pressing the buttons 26a,b of respective two devices 12a, 12b against each other as depicted in FIG. 5(b), the transfer of the content files is initiated. No disconnecting is needed. In a ‘Fly-by’ type concept 202 as depicted in FIG. 5(c), tags or magnetic induction technology is implemented such that the user pre-selects the content, e.g., represented as icons 95, and places it in a separate space 76. Two devices 12a, 12b are moved along each other in very close proximity in directions as depicted by arrows 86a,b to initiate the copying. As shown in FIG. 5(c) the devices are oriented horizontally and are virtually swiped next to each other lengthwise (without contact) to effect the content transfer. Multiple copies may be made this way and disconnecting is not needed. In a ‘Gravity’ type concept 203 depicted in FIG. 5(d), metal contacts, and infrared eye or magnetic induction are implemented such that the pre-selected content represented by icons 95 are put in a special space 76 for example, in device 12a. By placing the device 12a on top of transferee device 12b, as in a stack, for example in the manner as depicted in FIG. 5(d), the content transfer is initiated, as shown by the transferred icon in device 12b. After the content is transferred, connection is terminated. In a ‘Shake It’ type concept 204 as depicted in FIG. 5(e), acceleration sensors and infrared eye technology are implemented such that, transfer of pre-selected content, e.g., represented as icons 95, may be initiated when the devices 12a, 12b are placed together in an abutting fashion as depicted in FIG. 5(d) and shaken. After the ‘shaking’, the content items are transferred, e.g., from device 12a to device 12b. Disconnecting is performed automatically thereafter. In a ‘Liquid Content’ type concept 205 as depicted in FIG. 5(f), rotation sensors and infrared eye technology may be implemented such that transfer of pre-selected content, represented as icons 95, are first placed in a separate corner 77 of the screen display of a transferor device 12a, for example. The content transfer is then initiated when the transferor device 12a is held vertical and in close proximity to another transferee device 12b. When all content is transferred the connection is stopped.

With further respect to ‘Select & shoot’ concept depicted in greater detail in FIGS. 6(a)-6(c), the transferor user pre-selects the content he/she wants to send to another user.

Selecting the content items represented as icons 95, is performed by the user himself or after getting an indication from the other (transferee) user which items he/she would like to receive. As shown in FIG. 6(a), the user selects the items that will be copied to the other user and drags the items (icons) 95 into a separate send space 78 of the transferor device 12a. It is understood that a copy of each item is made to preserve the original. Until the moment of transfer there is no connection between the devices. When the devices are pointed at each other, a send button, e.g., 17a, is pressed and the transfer starts. In the visualization depicted in FIG. 6(b), the send space 78 moves towards the upper edge of the screen collapsing in size as depicted by arrows and effectively pushing the items 95 to the transferee device 12b. It is understood that the key and identification is exchanged before starting with the actual transfer. As shown in FIG. 6(c), after the transfer, the user's send space 78 lowers again as depicted by the arrows, however, items 95 may still remain in the ‘send space’ 78 for a second transfer to another user. The owner may add or remove some items before sending them to another user. It is also possible to permanently place popular items in the ‘send space’ 78. After transferring the items to the transferee device 12b, the devices do not have to be pointed at each other anymore. The transfer is carried out by the WiFi™ connection with a range up to 100 m. As further shown in FIG. 6(c), the items 95a transferred to the transferee's device 12b are placed in the user's personal space 25b between other possessed items. That is, incoming items 95a appear on the screen outside that devices ‘send space’ 78b. Feedback about new items may be given by an audible signal and the blinking of the items. Since the users are generally in close proximity, social interaction may be used to get feedback about whether the transfer was successful or not.

It is a feature of the invention to make content accessible for other users with decreased effort, e.g., a single action. Thus, adding a third space to the embodiments described with respect to FIGS. 4(a)-4(c) and 6(a)-6(c) that enables visualization of the items stored on other devices may reduce the effort needed for the owner when distributing items. With the permission of the owner, users can browse the items themselves instead of asking to place them in the shared space.

Thus, as shown in FIG. 7, after making contact to another device (not shown) the shared space 75 and a space 79 that includes the content of the other device (other space) is added to the PCC display screen 13 of the user device 12a. During contact, the spaces can be resized to maximize the work area. The presence of the three spaces 25a, 75, 79 adjacent each other creates a model in which the content items can be dragged, e.g., vertically, from space to space. The minimizing of spaces when not needed or the absence of them (when not connected), does not affect this model. Inaccessible spaces have minimal dimensions and are not resizable in order to maintain the spaces model. To keep the effective working space maximal, horizontal lines separate the spaces. Preferably, to give the user the control the spaces may be resized manually. The user can determine the size of the spaces to make the drag & drop actions easier to accomplish.

It should be further understood that as the stored content has a private nature it must therefore not be accessible to everyone. It is understood that, while this solution minimizes the combined effort for all users, privacy and security is still maintained.

As mentioned herein, when contact is made with another device, feedback is provided as to whether the connection was successful and with whom the connection has been made. This is realized by representing the connected user on the screen. Representing the connected user(s) may be done by displaying their names in a list or, preferably, as shown in FIG. 8, indicating their presence with an icon 88 which will enable the user more space to personalize on the screen 13. A picture or a character 89 may be used to identify the user which is sufficient when a small number of users are connected at the same time. Thus, just as the spaces concept relates the content to the storage locations, the same hold s for the use of user icons. That is, the icon of the connected user is related to the space that represents his content. To keep consistency the own space will also display an icon. The user can see how he/she is visualized on the other connected device. In one embodiment, the icons are placed in the border of the spaces to show their relation with the space. That is, when a connection is made, the user icon of the other user appears on the screen, preferably at the border of a space, e.g., a space dividing line. In a two-user situation both users see the icon of the other user on their screen.

When more users are connected, more icons appear on the screen. Giving each connected user his own space would make the screen overcrowded. The shared space shown in FIG. 8 still has the same meaning: the space 75 including all shared content The upper space 79 however now gets the meaning of space ‘that holds the content of the other users’. The content displayed here belongs to the user that is selected at that moment The icons are used for switching: tapping one of the user-icons makes that the upper space shows the content of that user, if accessible. FIG. 8 illustrates a PCC device 12a having three spaces 25a, 75, 79 and a user icon 89a generated for display on the border 99 of the upper space 79 within a circle 88a for example, and used for indicating connection with that user. In one embodiment, the spaces may be rendered in a different color to make them better distinguishable. In the embodiment shown in FIG. 8, two users are shown connected and one user represented by icon 89 within circle 88 has opened his/her space and the other user, indicated by icon in circle 91 shows a connected user that has closed his/her space. Preferably, each user 89, 91 can ‘flip’ his personal icon from the left to the right to ‘open’ his/her space for the other users. On the screen of the connected users his icon then changes from ‘closed’ to ‘open’.

When two devices are connected items can be shared using the shared space. This provides the user total control about the content that is accessible for other users. As mentioned herein, when an item is dragged to the shared space, a copy is made. When the other user is looking for a specific item or just wants to browse through the items of another user, permission from the latter is needed. In most cases, this will be done simply by asking. When two users are familiar with each other, the permission can also be given without asking. Since no distinction is made in access level concerned the shared space, the same will be done with the ‘browsing’ mode. When a user gives permission, all users can browse his personal content. Apart from indicating the presence of other users, their access level (‘open’ or ‘closed’) is also visualized by the user icons.

FIGS. 9(a)-9(b) show two example variations of a lower border bar 29 that borders the lower space holding the content stored on the own device. The width of both lower bar 29a,b depicted match the device screen size. Since opening the user's personal space means giving access to other users and permitting them to drag items from this space to their own, it was chosen to visualize this by creating an opening in the closed border. Opening the own space FIG. 9(b)) swaps the user icon 89 to the right creating a passage in the normally closed border. The little toggle button 82 allows the user to switch at any moment he wants. When at least one of the connected users has opened his space, the upper space is accessible and thus resizable. A handle 83 in the middle of the border allows the user to resize the space manually. Preferably, when none of the connected users have opened their spaces the handle is not available. The user's own space is always accessible and therefore always resizable. Each user can at any time ‘open’ or ‘close’ his space by creating or closing a passage in the border. This provides the two ways of sharing content: sharing with a maximum of privacy and security and browsing, providing access to content stored on other devices, making it possible to quickly locate an item without effort needed from the owner. Spaces can only be resized when access is granted.

The huge collection of content, e.g., music and photos has to be organized in such a way that the user can easily and quickly navigate through all his content. Two ways of content organization can be distinguished: A hierarchical structure including organizing all content by placing it in folders that may include several related items. The same can be done with folders. Such an organization with multiple levels arises related to the way people store their content in the real world. Network structures only have one level. To find the way in this large pile of items smart search engines and filtering systems are put on top. The user can use keywords or indicate a direction and the system automatically generates a set of items that meets the criteria. To accomplish, this metadata is needed. Often a combination is used since people have the need to store related items in albums (photo books, CD's). The combination of a flexible structure and albums on the lowest level is proven.

The metadata available is often limited to song title and artist regarding downloaded MP3 songs. In the case of photos, the user often transfers them from his digital camera without renaming them or adding extra information (such as the location the photo was taken). In most cases only date information is included. Although technologies that generate or extract metadata automatically such as integrated GPS systems and photo analyzing software are gaining ground, with the expected usage scenarios not much metadata will be available. The lack of metadata makes the classic hierarchical structure more suitable. As little levels as needed were added to minimize the effort for the user. Photos, as well as music songs, are considered to be stored in albums.

The photos and music songs are stored in albums, which when opened, its contents are made visible. Preferably, music and photos are stored separately, for example, and the content of an album may be displayed in the same level, e.g., opening a folder in left column of a Windows Explorer type folder structure. Preferably, a one level structure is provided in order to avoid buttons to switch between the levels. Tapping it once can open an album and the album's metadata content may be displayed below the album icon that now indicates it has been opened as shown in FIG. 10(a) with an example text view (music) and in FIG. 10(b) with an example thumbnail view (photos). Closing an album may be performed by tapping it again or opening one of the other albums that are lined up under the opened album.

To perform a drag & drop operation (e.g., by tapping & dragging an item with the stylus) possible between all spaces, only one content type at the time is displayed in all spaces. This is to avoid a situation of dragging a photo into a space where music songs are displayed. A switch button allows the user to switch between the content types when he/she wants. Items can be represented by thumbnails 95a (e.g., for FIG. 10(b) photos) or by text 95b (e.g., for FIG. 10(a)), or both. Text specifies the picture in the case two photos look the same. With music albums, thumbnails can help identify an album when the user knows what it looks like. Separate songs often do not have a picture. For quick browsing, a text presentation is more effective while thumbnails are more fun to use. For these reasons two modes were created between which the user can switch. Since the items can be dragged, they may look like objects, e.g., by adding a little shadow. As shown in FIGS. 10(a) and 10(b), to browse through the content, standard scrollbars or like scroll mechanisms 66 may be used. To indicate their relation with the space, the scrollbar preferably has the same color of the space it is in.

As shown in FIG. 1, the lower part of the screen 13 includes a button menu 115 providing buttons enabling functionality for switching between the content type (music and photo) buttons 116, 117, and the presentation mode, e.g., thumbnail and text, 118, 119. These text and thumbnail buttons may also appear on the side of the content type that is selected to indicate their relation. Feedback is given to change the color of the selected button and the type of content that is played on the screen. Thus, to indicate the origin of a content item, the items have the same color as the background color of the space they originate from.

FIG. 12 illustrates two example items 95a,b in the shared space 75 of a user device 12a. One item 95a is of a first color (e.g., blue) indicating that it was transferred from the blue space and thus provided by the owner of this device 12a. Assigning the personal colors to the items in the shared space makes it easy to distinguish items from the various owners. When an item is retracted to the personal space again, it is removed from the space. Dragging a second item, e.g., a yellow colored item 95b, owned by a connected user, into the personal space starts the copying. The yellow item changes slowly into blue when placed in the personal blue space. This color change provides two kinds of information at the same time. It indicates the other user now also owns the item. Transfer feedback is given by using the text bar as a progress bar (not shown). Dragging items indicating actions that cannot be performed (like dragging an item into the personal space of the other user) are cancelled accompanied by a sound signal.

Since the users can always disconnect, it is only allowed to transfer one item at the time. This avoids situations were multiple items are being downloaded. While the owner disconnects and all downloads are lost Dragging items to the personal space and releasing them places them between the albums. Releasing items on an album, places them into this album so as to avoid an ‘inbox’ where items are stored temporarily.

A first exemplary embodiment illustrating the user interface concept according to the present invention is now described. As described herein, pointing two PCC devices at each other and pressing the link buttons, for example, will establish a connection between the devices. Keeping the buttons pressed for a short time, establishes a link. Feedback about the successful connection may be given by a sound signal.

In operation, a start screen on a device provides an upper border (not shown) that is dynamically lowered to indicate a second border to expose the presence of the shared space region. The user icons are placed in the circles as described herein with respect to FIG. 8. The content type switch buttons as well as the content view buttons (FIG. 11) are placed on the bottom. When a third user joins by connecting and linking with one of the devices, all three users see each other as shown in the screen display (FIG. 8) which shows the presence of two connected users, for example, one ‘open’ and the other one ‘closed’. The owner has also closed his space here (FIG. 9(a)).

With respect to navigating through content, as now depicted as a scenario 300 in FIG. 13(a), a screen 300 is generated depicting that the owner of the PCC device 12a and all connected (second and third) users have opened their personal spaces as represented by respective icons 301, 302 and 303. The personal space 25a is maximized by dragging the handle 83 upwards as depicted by arrow 84. This action automatically minimizes the other spaces. Albums 95 may then be opened by tapping on them so that the content is displayed underneath. Scrollbars 66 depicted in FIG. 13(a) may then be used to browse through all items in a space. Although not shown, selecting the ‘text view’ button 119 for instance, will generate for display all items without thumbnails and a larger name (e.g., metadata description).

With respect to exchanging items, an item may be placed in the shared space 75 and initially hold the color of the space they originate from. Upon dragging an item 95a to the personal space as shown in FIG. 13(b), a transfer starts with feedback given by changing color of the copied item. The same holds for downloading items from the personal space of other users. Items can be retracted from the shared space 75, simply by dragging them back to the personal space.

With respect to rendering of items in the display screen, only items that are located in the personal space can be rendered. When tapping items in other spaces, a sound gives feedback this is not possible. Photos may be displayed full screen; and music can be listened through a speaker or headphones. To view landscape photos, the device has be rotated 90 degrees. Disconnecting is performed by pressing the same button that is pressed for connecting. Pointing at the other device is not necessary as the action may be performed without the cooperation of another user.

It should be understood that items may be placed in the ‘shared space’ 75 without being connected. The items placed here are immediately accessible for others after connecting. The space is opened by dragging down the border, and, just like sharing when connected, a copy is initiated. Since the shared space holds the items shared by all users, after disconnecting the space empties. However, in a not connected state it still remained possible to copy items to the shared space. Pre-placed items (by others) appear in the shared space upon connecting with them. The temporary character of the items in this space interferes with the possibility to use it also in the stand-alone mode. Dragging an item to the shared space is obvious making a copy, leaving the personal collection untouched.

Thus, after disconnecting, the shared space disappears completely to emphasize its temporary character, i.e., there is no shared space in the stand-alone mode. Thus, as shown in a further embodiment for the user interface 400 depicted in FIG. 14(a), only the user's personal space 410 is provided in a stand-alone mode. In the view depicted in FIG. 14(a), three collections 405a-405c are available in a top level navigation view. The border 401 has moved automatically to the top of the screen, and an audio/video player 415 appears below the screen. As shown in FIG. 14(a), the personal icon is hidden to save screen space in the stand-alone mode. Although not shown, in this second embodiment, a multi level structure is supported for content navigation. Tabs appearing on the left side of the screen provide feedback about the present location. Clicking an underlying tab shows a level more on top.

The temporary character of the shared space implies that items disappear after the owner disconnects. This might necessitate quick grabbing of the items. The small screen does not offer enough space to visualize both spaces completely. In order to copy the items into the right location, actions like scrolling and navigating between different levels in the hierarchy are needed. Since these actions take time, an option to place the downloaded items on the temporary location is preferable, and subsequent thereto, organization of the content can be performed. Preferably, this ‘temporary location’ does not interfere with the concept of the spaces and, thus, a temporary space is located within the user's personal space, since the items are already downloaded and does not increase the complexity of the user interface.

A temporary place to park items (i.e., shared space) is opened when sliding over with an item and closes again when it includes no items anymore. Dragging an item to this area makes a copy, dragging an item from the area involves a move action. To minimize the number of items in the shared space, items are deleted from the space when every connected user has downloaded them. On the other hand, items that are still not downloaded by everyone should be accessible as long as possible. When the original owner disconnects, the item also disappears. However, when at least one of the others users has already downloaded the item, he/she could replace this item. This action can also be performed by the system. The item simply changes color in the shared space, indicating another user is now controlling it.

Functionality for enabling users to preview items before downloading them is provided. This can be useful since the screen space only offers a minimal amount of information of the items. Thus, to be sure to download the right item or when just browsing, the option of previewing is provided. The rendering of items from the shared space is aborted when the owner disconnects. The user should therefore be informed when viewing or listening to items he does not own. This may be indicated to a user by changing the color of the audio and video player 415, for example by enabling the player to take the color of the user to which the item belongs.

As mentioned, the personal space in the stand-alone mode is illustrated in FIG. 14(a). Here, the top level shows three collections 405a-405c. After connecting with another user, the border 401 lowers, the owner's icon 408 is generated for display as is the user icon 409 of the other connected user, and the shared space 475 is generated as shown in FIG. 14(b). The audio player is minimized to provide more screen space. In FIG. 14(c), the ‘music albums’ collection 405b is opened. A tab 412 on the left appears, indicating the current location. By tapping a portion of the tap, the user is returned to the top level. As shown in FIG. 14(d), dragging an item 415 to the shared space 475 makes a copy. The item now becomes visible on all connected devices. The transparency indicates the user already possesses the item, to clear the view on the ‘new’ content.

As shown in FIG. 14(e), the connected user shares his photo collection indicated by icon 416 with the original user as indicated by its addition to the shared space 475. As shown in FIG. 14(e), the collection 415 on top level is dragged into the shared space 475. Tapping the collection via a touch screen interface shows the albums it contains, such as album 425 indicated in FIG. 14(f). The tab 422 on the left side of the screen provides an indication of the navigation and preferably, is rendered the same color of the other user. Opening the album 425 shows the picture contents 435 as shown in FIG. 14(g). As shown in FIG. 14(g), a scrollbar 430 is displayed to provide a scrolling function when the amount of items 435 can not fit in the screen display area. The tab 432 shows the third level and gives metadata information about the opened album 425. As shown in FIG. 14(h), two photos 435a,b are dragged to the user's (temporary) personal space 485. By sliding over the border, the ‘temporary space’ 485 opens and copies are made. The item can be placed here or can be stored in an album at once. Feedback about the transfer progress is given by the changing color. As depicted in FIG. 14(i), after minimizing the shared space 475, the downloaded items 435a,b can be organized, for example, by moving them to an album or collection. When the temporary area 485 is empty, it closes automatically.

After pointing and linking to another user in the manner as described herein, the icon 407 of that new user appears on all connected devices as shown in FIG. 14(j). When maximizing the shared space 475, the user's temporary space 485 automatically becomes visible to enable quick downloading (organizing may be performed later). As shown in FIGS. 14(k)-14(l), the third user's content items 490 have been placed in shared space 475. FIG. 14(l) particularly depicts content items 495 rendered in the color identifying the third user's content.

When a hard button is pushed again, the device disconnects from the group. After disconnecting, the shared space disappears. When a photo is rendered in the shared space, the player gets the color of the user that owns the item. This emphasizes a preview is being made which can be aborted when the owner disconnects.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A system for ad hoc sharing of content stored in portable devices, said system comprising:
a) a means for establishing a communications link to connect a single portable device to one or more other portable devices;
b) means for generating a visualized shared space on a display area of each portable device of a connected user for facilitating content exchange between connected users via established communications links; and
c) means for enabling each individual connected user to control transfer of content to and from that user's portable device via said communications link in response to manipulation of items representing user content in said shared space.

2. The system as claimed in claim 1, wherein said display area comprises a user space for displaying items representing content stored in said portable device, wherein a copy of said content is available for transfer to a connected user by moving an item representing said content from said user space to said shared space, said moved item being displayed in a shared space on each connected user's device.

3. The system as claimed in claim 2, wherein a copy of said content is transferred from a transferor device to a transferee device via an established communications link in response to moving an item representing said content from said shared space to said user space of a transferee device.

4. The system as claimed in claim 1, further comprising means for indicating to a user a status of being connected during which time content items can be freely exchanged between portable devices of all connected users.

5. The system as claimed in claim 4, whereby said means for establishing a communications link further includes means for enabling secure encrypted communications.

6. The system as claimed in claim 5, whereby said means for establishing a communications link with a connecting user is by wireless RF communications.

7. The system as claimed in claim 5, whereby said means for establishing a communications link with a connecting user is by Infrared communications.

8. The system as claimed in claim 5, whereby a communications link connecting a single portable device to one or more other devices is established when said devices are in close distance range to each another.

9. The system as claimed in claim 8, whereby a communications link becomes automatically disconnected when said devices are out of communication range from each another.

10. The system as claimed in claim 5, whereby a communications link connecting a single portable device to another device is established when said devices contact each other, wherein content may be transferred between devices while in said contact.

11. The system as claimed in claim 5, whereby a communications link connecting a single portable device to another device is established when said devices are positioned one on top of another, wherein content may be transferred between devices while in said on top position.

12. The system as claimed in claim 5, whereby a communications link connecting a single portable device to another device is established when said devices are first in close proximity and in motion relative to one another, wherein content may be transferred between devices while in said motion.

13. The system as claimed in claim 5, further including means for generating a space in said display area on a transferee portable device indicating content included in a transferor portable device, said transferee user being enabled to transfer content from said transferor portable device to said shared space via said transferee device.

14. The system as claimed in claim 4, wherein said means indicating status of a user includes means for generating a graphic for display to indicate the presence and identity of a connected user and providing indication of whether content is or is not provided by said connected user in said shared space.

15. The system as claimed in claim 12, further including means for providing visual indication for identifying content in said shared space owned by a particular connected user.

16. The system as claimed in claim 15, wherein said visual indication is a color indication.

17. The system as claimed in claim 12, further including means enabling switching display of content items in said portable device according to graphic or textual views.

18. The system as claimed in claim 14, further including means providing metadata information associated with content items displayed in said display area.

19. The system as claimed in claim 14, wherein said shared space of a user's device is populated with items already in said shared space as placed by other users upon connection.

20. The system as claimed in claim 14, wherein said content items associated with a first user are removed from the shared area of a connected user's portable device when the first user's communications Link is disconnected.

21. A method for ad hoc sharing of content stored in portable devices, said method comprising steps of:
a) establishing a communications link to connect a single portable device to one or more other portable devices;
b) generating a visualized shared space on a display area of each portable device of a connected user for facilitating content exchange between connected users via established communications links; and
c) enabling each individual connected user to control transfer of content to and from that user's portable device via said communications link in response to manipulation of items representing user content in said shared space.

22. The method as claimed in claim 21, wherein said display area comprises a user space for displaying items representing content stored in said portable device, said step c) of controlling transfer comprising: moving an item representing said content from said user space to said shared space for making a copy of said content available for transfer to a connected user, said moved item being displayed in a shared space on each connected user's device.

23. The method as claimed in claim 22, wherein said step c) of controlling transfer comprises: moving an item representing said content from said shared space to said user space of a transferee device and initiating transfer of a copy of said content from a transferor device to a transferee device via an established communications link in response to.

24. The method as claimed in claim 21, further comprising the step of indicating to a user a status of being connected during which time content items can be freely exchanged between portable devices of all connected users.

25. The method as claimed in claim 24, whereby step of establishing a communications link further includes communicating first information enabling secure encrypted communications between connected devices.

26. The method as claimed in claim 25, whereby said step of establishing a communications link with a connecting user includes implementing wireless RF communications.

27. The method as claimed in claim 25, whereby said step of establishing a communications link with a connecting user includes implementing Infrared communications.

28. The method as claimed in claim 25, wherein said step of establishing a communications link occurs between a single portable device and one or more other devices according to distance range of said devices with respect to each other.

29. The method as claimed in claim 25, further including the step of automatically disconnecting a communications link when said devices are out of communication range from each another.

30. The method as claimed in claim 25, wherein said step of establishing a communications link to connect a single portable device to another device includes touching said devices with each other, and transferring content between said devices while in said contact.

31. The method as claimed in claim 25, wherein said step of establishing a communications link to connect a single portable device to another device includes positioning a portable device on top of another device, and transferring content between said devices while in said on top position.

32. The method as claimed in claim 25, wherein said step of establishing a communications link to connect a single portable device to another device includes moving said devices in close proximity relative to one another, and transferring content between said devices while moving.

33. The method as claimed in claim 25, further including the step of generating a space in said display area on a transferee portable device indicating content included in a transferor portable device, said method including enabling a transferee user to transfer content from said transferor portable device to said shared space via said transferee device.

34. The method as claimed in claim 24, further including the step of:
generating a graphic for display to indicate the presence and identity of a connected user and providing indication of whether content is or is not provided by said connected user in said shared space.

35. The method as claimed in claim 35, further including the step of: providing visual indication for identifying content in said shared space owned by a particular connected user.

36. The method as claimed in claim 35, wherein said visual indication is a color indication.

37. The method as claimed in claim 32, further including the step of switching display of content items in said portable device according to graphic or textual views.

38. The method as claimed in claim 32, further including the step of providing metadata information associated with content items displayed in said display area.

39. The method as claimed in claim 24, further including the step of populating said shared space of a user's device with items already in said shared space as placed by other users upon connection.

40. The method as claimed in claim 24, further including the step of removing content items associated with a first user in said shared space of a connected user's portable device when the first user's communications link is disconnected.
